(19) United States
(12) Patent Application Publication
(10) Pub. No.: US 2007/0250781 A1
(43) Pub. Date: Oct. 25, 2007

(54) METHODS AND ARRANGEMENTS FOR SUPPLEMENTING STATIC CONTENTS

(76) Inventor: Blaine H. Dolph, Western Springs, IL (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/379,389

(22) Filed: Apr. 20, 2006

(51) Int. Cl. G06F 3/00

(52) U.S. Cl. 715/745

(57) ABSTRACT

Methods and arrangements to supplement static contents are contemplated. Embodiments include transformations, code, state machines or other logic to supplement static contents by receiving a command to play static contents, the static contents comprising primary content and an original preview. The embodiments may include deciding to replace the original preview in the static contents, selecting replacement content for the original preview, downloading the replacement content, and playing the replacement content in place of the original preview. In some embodiments, the replacement content may include newer previews, advertisements, announcements of live performances, public service messages, anti-piracy messages, updates on awards, and corrections to the static contents. In some embodiments, the static contents may be tagged with information about the static contents which is used to select replacement content. In some embodiments, replacement content may be selected via the application of rules. In some embodiments, replacement content may be selected via an interactive user interface.

### FIELD

The present invention is in the field of players of the contents of storage media. More particularly, the present invention relates to methods and arrangements for replacing one or more previews contained in static contents on storage media.

### BACKGROUND

Some of the contents included with a movie recorded on a compact disk (CD), a DVD, a video home system (VHS) tape or another storage medium may become outdated. For example, a commercial package containing a featured movie may also include two to four previews of movies to appear in theatres in the next few weeks after the release of the commercial package. These previews may not be useful after the previewed movies have left the theatres.

These movies and previews stored on storage media are examples of static content. Static content may be primarily fixed and unchanging; that is, the content that is stored on a storage medium may be played each time the storage medium is played. The content may represent sensory stimuli such as audio, video, combinations of audio and video, still images, text, and other materials for viewing or listening. For example, the static content may consist of movies, film, documentaries, cartoons, video recordings, plays, music videos, music audio, lectures, audio books, audio recordings, slides of images, slides of text, photographs, or other similar content. The static content may be played and perceived. The static content may not represent instructions to be executed, such as a computer program or a video game.

As with the specific example of previews included with movies, in general static content may become outdated, be inaccurate, be incomplete, or may otherwise need replacement. For example, information included with a movie about awards and award nominations may become outdated. Cast information may be inaccurate. Related events occurring subsequent to a movie about a real-life event may be of interest to viewers. Similarly, information included with other static content may be incorrect or outdated, such as previews, information about other releases by the same artists, and information about tours by the artists included with a music recording and information such as captions and information about the artists contained with still images.

It may be difficult or impossible to revise static contents. Some static content may be stored on a storage medium which cannot be rewritten. The storage medium may be read-only, such as many CDs and DVDs. Similarly, the file parameters of the stored static contents may prevent rewriting. The static contents may be write protected or stored in a file format that is available for reading but not writing. Even when rewriting is possible, it may not be known that revision would be useful. For example, a movie viewer may not know that cast information is incorrect. In addition, the viewer may not know of replacement materials or how to obtain them. For example, even though a person realized that the previews included with a movie were out of date, the person may not know of current previews or how to obtain them.

### SUMMARY OF THE INVENTION

The problems identified above are in large part addressed by methods and arrangements for supplementing static contents. One embodiment provides a method to supplement static contents. The method may involve receiving a command to play static contents, the static contents comprising primary content and an original preview. The method may involve deciding to replace the original preview in the static contents, selecting replacement content for the original preview, downloading the replacement content, and playing the replacement content in place of the original preview.

Another embodiment provides an apparatus to supplement static contents. The apparatus may comprise a user interface to receive a command to play static contents, the static contents comprising primary content and an original preview; a replacement manager to decide to replace the original preview in the static contents and to select replacement content; a network module to download the replacement content; and a contents player to play the downloaded replacement content.

Another embodiment provides machine-accessible medium containing instructions to supplement static contents which when the instructions are executed by a machine, cause said machine to perform operations. The operations may involve receiving a command to play static contents, the static contents comprising primary content and an original preview. The operations may also involve deciding to replace the original preview in the static contents, selecting replacement content for the original preview, downloading the replacement content, and playing the replacement content in place of the original preview.

### BRIEF DESCRIPTION OF THE DRAWINGS

Advantages of the invention will become apparent upon reading the following detailed description and upon reference to the accompanying drawings in which like references may indicate similar elements:

FIG. 1 depicts an embodiment of a network-enabled contents player;

FIG. 2 depicts an embodiment of a static content supplementer; and

FIG. 3 depicts a flowchart of an embodiment to supplement static content.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements to supplement static contents are contemplated. Embodiments include transformations, code, state machines or other logic to supplement static contents by receiving a command to play static contents, the static contents comprising primary content and an original preview. The embodiments may include deciding to replace the original preview in the static contents, selecting replacement content for the original preview, downloading the replacement content, and playing the replacement content in place of the original preview. In some embodiments, the replacement content may include newer previews, advertisements, announcements of live performances, public service messages, anti-piracy messages, updates on awards, and corrections to the static contents. In some embodiments, the static contents may be tagged with information about the static contents which is used to select replacement contents. In some embodiments, replacement content may be selected via the application of rules. In some embodiments, replacement content may be selected via an interactive user interface.

While specific embodiments will be described below with reference to particular circuit or logic configurations, those of skill in the art will realize that embodiments of the present invention may advantageously be implemented with other substantially equivalent configurations.

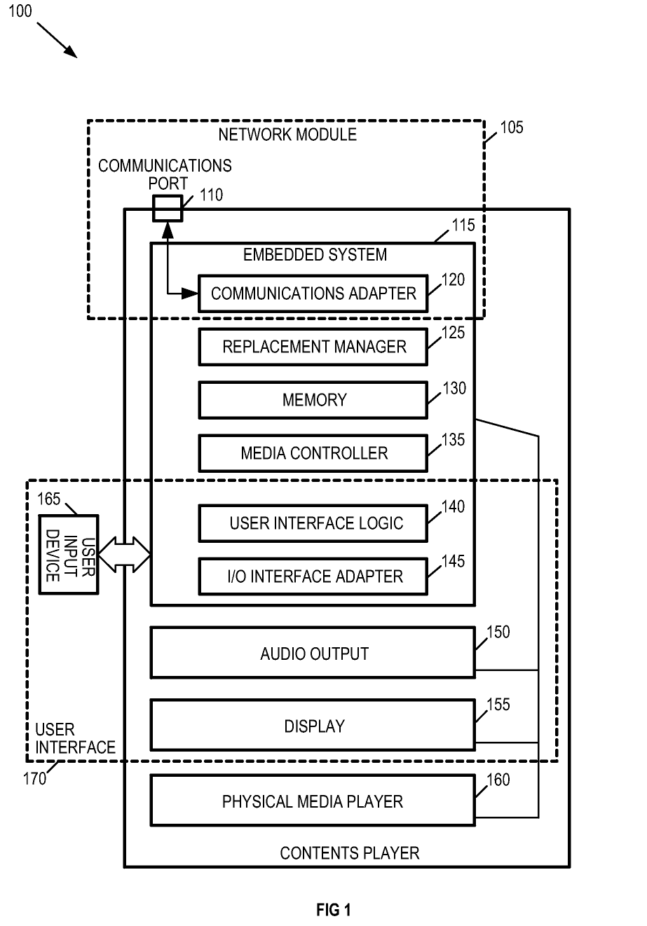

FIG. 1 depicts an embodiment of a contents player 100 with a user input device 165, a communications port 110, an embedded system 115, a physical media player 160, a display 155, audio output 150, network module 105, and user interface 170. Contents player 100 is a device to play contents, including the static contents of storage media. The storage medium may consist of a removable digital storage medium such as compact disk (CD); DVD; Blue-ray disks; high definition DVD (HD-DVD); digital audio tape (DAT); Secure Digital, Compact Flash, and Smart Media flash memory cards; an analog storage medium such as audio cassette tape or Video Home System (VHS); or RAM or flash memory or other storage contained in a computer or other processing device.

In general, static content may be primarily fixed and unchanging; that is, the content that is stored on a storage medium may be played each time the storage medium is played. The content may represent sensory stimuli such as audio, video, combinations of audio and video, still images, text, and other materials for viewing or listening. For example, the static content may consist of movies, film, documentaries, cartoons, video recordings, plays, music videos, music audio, lectures, audio books, audio recordings, slides of images, slides of text, photographs, or other similar content. The static content may be played and perceived. The static content may not represent instructions to be executed, such as a computer program or a video game.

As with the specific example of previews included with movies, in general static content may become outdated, be inaccurate, be incomplete, or may otherwise need replacement. For example, information included with a movie about awards and award nominations may become outdated. Cast information may be inaccurate. Related events occurring subsequent to a movie about a real-life event may be of interest to viewers. Similarly, information included with other static content may be incorrect or outdated, such as previews, information about other releases by the same artists, and information about tours by the artists included with a music recording and such as captions and information about artists contained with still images. Outdated and inaccurate static content may be supplemented by replacing it with more recent or more accurate content. Incomplete static information may be supplemented by providing additional information.

Contents player 100 may comprise a specific-purpose device such as a CD or DVD player, a video cassette recorder (VCR), an MP3 player, a device to play slides or other visual data, or other devices to present the content of a specific medium; a general-purpose device such as a computer or other processing device; or a device to play video games such as a PlayStation 3. Contents player 100 may supplement static contents such as previews by receiving a command to play static contents, deciding to replace a portion of the static contents, selecting replacement content such as a more recent preview, downloading the replacement content, and playing the replacement content.

User input device 165 may receive user input related to the playing of the contents of a storage medium. The user input device 165 may enable a user to navigate through the contents on the medium, to play or halt the playing of the contents, and to select options to govern the playing of the contents of medium. For example, a device to play movies may permit a user to select previews, particular segments of a movie, interviews, or other extra features. The device may also permit a user to select the screen format (wide-screen or normal), the language of subtitles, and other options in the playing of the movie. The nature of the user input device 165 may depend upon the type of the media player. A general-purpose computer may include a mouse and keyboard as user input devices. Some computer embodiments of a media player may include other forms of user input such as voice commands, tablets or touch screens. An input device for a VCR, CD player, or DVD player may include buttons on the device itself for entering commands. For example, a VCR may contain buttons to record, play, fast-forward, double-fast-forward, pause, stop, rewind, rewind-fast, and eject. An input device for a VCR, CD player, or DVD player may include a remote control as a user input device. The remote control may contain various buttons for entering commands. An input device for a game player may consist of a game controller.

Embedded system 115 includes communications adapter 120, replacement manager 125, media controller 135, user interface logic 140, input/output (I/O) interface adapter 145, and memory 130. Embedded system 115 may consist of special purpose hardware and software to perform the processing functions of contents player 100. Embedded system 115 may receive user input commands and user options from user input device 165 and may issue commands to physical media player 160 concerning the playing of the contents of storage medium. Embedded system 115 may decide to replace a portion of static contents, may select replacement content such as a more recent preview, may download replacement content, and may command the playing of the replacement content. Communications adapter 120 may implement data communications such as communications over a network for contents player 100. The communications may include the downloading of content to replace static content. Such data communications may be carried out serially through RS-232 connections, through external buses such as USB, through data communications networks such as Internet Protocol (IP) networks, and in other ways as will occur to those of skill in the art. Communications adapters implement the hardware level of data communications through which one device sends data communications to another device, directly or through a network. Examples of communications adapters may include modems for wired dial-up communications, Ethernet (IEEE 802.3) adapters for wired network communications, and 802.11b adapters for wireless network communications. Contents player 100 connects to a network or other external data source through communications port 110.

Replacement manager 125 may determine whether to supplement the static contents of storage media and, if so, may determine supplemental contents. Replacement manager 125 may determine that static contents stored on a medium are obsolete or otherwise should be replaced or may determine that additional contents should be presented without replacing any stored contents. User interface logic 140 may consist of instructions to govern user input and output. User interface logic 140 may interpret input from a user for the playing of supplemental contents and static contents of storage media and may control the presenting of information to a user about playing contents.

I/O interface adapter 145 may implement user-oriented input/output through, for example, software drivers and hardware for controlling output to display devices such as display 155 and audio output 150, as well as user input from user input device 165. Media controller 135 may implement reading from a storage medium. Memory 130 may provide working memory for the operation of embedded system 115 and may provide storage for software instructions used by embedded system 115. Memory 130 may consist of RAM or non-volatile memory or a combination of both.

Physical media player 160 may implement the physical aspects of reading from a storage medium. The physical media player 160 may consist of a special-purpose device to play the contents of a specific storage medium. A CD player or DVD player, for example, may include a platform to hold a disk, a motor to spin the disk at the proper speed, a laser to shine on the disk, and a sensing device to sense the laser beam after reflection from the disk. An audio tape player or VCR may include a motor to move the tape and magnetic heads to read the tape. Display 155 provides visual output for contents player 100. In some embodiments, display 155 displays the contents of storage media, such as movies, videos, or slides. In some embodiments, such as media players for audio disks, display 155 may display user options, provide instructions to a user, or provide information about the contents being played. For example, display 155 may display the track of an audio CD or DVD, the title, the composer, or other information about a piece of music being played. In some embodiments, display 155 may utilize a cathode ray tube, liquid crystal display, light-emitting diode, gas plasma, or other projection technology. Display 155 may range in size from a large screen or monitor for showing movies or other visual content to a small panel for showing information about the playing of media contents. In some embodiments, display 155 may consist of a monitor for a desktop computer or a screen for a laptop. In some embodiments, display 155 may consist of a TV screen hooked up to a CD or DVD player or video game console. Audio 150 provides sound output for contents player 100. In some embodiments, audio 150 may consist of a speaker or speakers. The speakers may be built-in or may plug into contents player 100. In other embodiments, audio 150 may consist of headphones which plug into contents player 100.

Network module 105, indicated by dashed lines, includes communications port 110 and communications adapter 120. Network module 105 may implement network communications for contents player 100, transmitting information about supplementing or replacing static contents and receiving supplemental contents and information about supplemental contents. User interface 170, indicated by dotted lines, includes user input device 165, user interface logic 140, I/O interface adapter 145, audio output 150, and display 155. User interface 170 may provide an interface for receiving input from a user for the playing of static contents of storage media and supplemental contents and for presenting information to a user about playing contents. User interface 170 may receive input from a user through user input device under the control of I/O interface adapter 145. User interface 170 may present information to a user through audio output 150 or display 155.

Alternative embodiments of a contents player may include alternative or additional components. A media player may consist of a general purpose device such as a computer rather than a special purpose device to play the contents of storage media such as a DVD player or CD player. A computer which plays media may include a general-purpose operating system such as Windows or UNIX rather than a special-purpose operating system included in an embedded system. A media player which plays slides or other strictly visual output may lack a means of audio output. In alternative embodiments, a user interface may consist solely of user interface logic or may consist solely of physical devices such as a user input device and an output device. Some embodiments may include a single output device, such as an audio output device or a display.

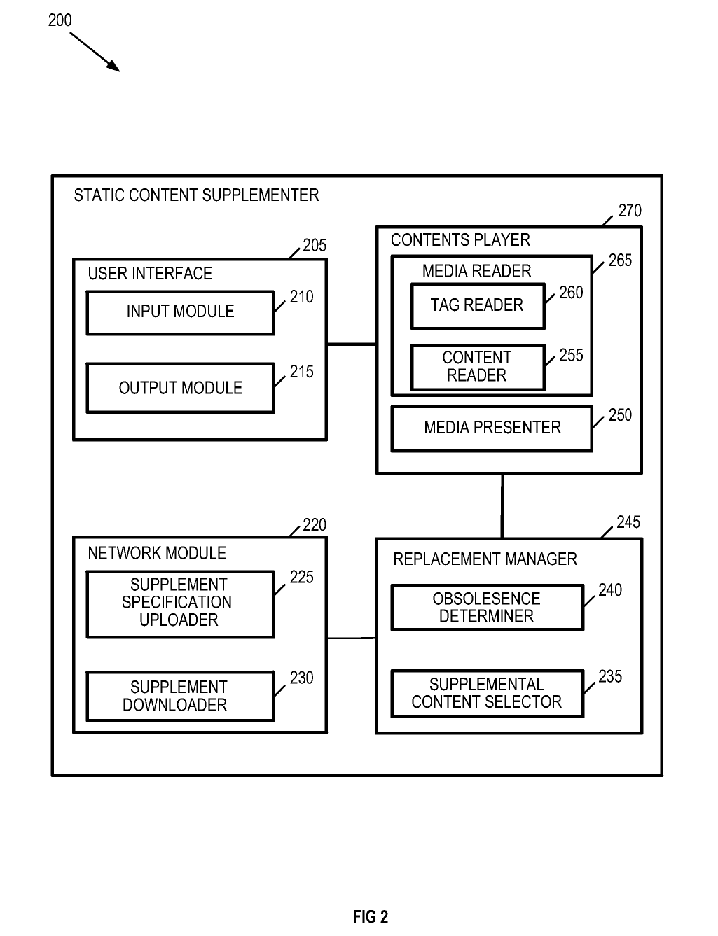

Turning to FIG. 2, depicted is an embodiment of a static content supplementer 200 that includes a user interface 205, a contents player 270, a network module 220 and a replacement manager 245. Static content supplementer 200 may supplement static contents stored on a storage medium. For example, static content supplementer 200 may receive a command to play a movie DVD which includes an outdated preview. The preview may be of a movie which is no longer playing in theaters or which has been released in DVD format for a considerable time. Static content supplementer 200 may decide that the preview is outdated, select a more recent preview, download the more recent preview, and display the more recent preview.

User interface 205 includes input module 210 and output module 215. User interface 205 may provide an interface for receiving input from a user for the playing of supplemental contents and static contents of storage media and for presenting information to a user about playing contents. Input module 210 receives input from a user. The input may include commands to play the contents of a storage medium, such as a video stored on a CD, a DVD, or VHS tape; audio stored on a cassette tape or an MP3 player; or other contents stored on other media. The input may consist of a command to play all of the contents or a command to play a particular portion of the contents. For example, a user may command the playing of a particular scene of a movie, a preview of a music or movie video, or an interview. The input may consist of commands to navigate through the contents of a storage medium, such as moving to a particular track of an audio CD or moving to a particular scene of a movie, with such commands as fast forward and reverse. The input may consist of commands halting the playing of the contents stored on a medium, such as pause, stop, or eject. In some embodiments, a static content supplementer may play the contents of multiple media, and the commands may select the type of medium to be played.

Output module 215 may present to a user static and supplemental contents and information about playing static contents and supplemental contents. Output module 215 may present information about the contents being played, such as the title, participants, length, date, producers, track or other subdivision, and elapsed time. In addition, in some embodiments, output module 215 may present to a user options about selecting supplemental contents and the user may then select from the options through input module 210. In some embodiments, a user may choose whether or not to receive supplemental contents by interacting with input module 210 and output module 215. In further embodiments, the user may choose to play static media contents even though the contents are out of date. In some further embodiments, the output module 215 may present a user with a choice among items of supplemental contents, and the user may specify a selection through the input module 210. In other further embodiments, the output module 215 may present a user with a choice of whether to play a particular item of supplemental contents, and the user may indicate whether to play the item of supplemental content through input module 210. In some embodiments, a user may interact with input module 210 and output module 215 to specify preferences for receiving supplemental contents. For example, in some embodiments of static content supplementers which play movies, the user may indicate a desired type of movie previews. The user may specify desired genres, actors, directors, or writers. In some embodiments of audio media players, the user may specify a geographic region and request to be informed of live concerts in the area.

Network module 220 includes supplement specification uploader 225 and supplement downloader 230. Network module 220 may implement network communications, transmitting specifications about supplemental contents and receiving supplemental contents and information about supplemental contents. Supplement specification uploader 225 transmits specifications about supplemental contents. In some embodiments, the specifications about supplemental contents may include information about contents. For example, in replacing a preview of a movie, information about the title of the preview, the genre, the main actors, the director, and the writer may be transmitted to aid in selecting supplemental contents. In some embodiments, the transmitted information may include user information about a choice of supplemental contents. The user may select specific supplemental contents or may select a general category of supplemental contents, such as comedies or movies starring a particular actor. In some embodiments, the specification about supplemental contents may consist of an identification of supplemental contents. The replacement manager 245 may communicate directly with a user to determine the identification of supplemental or replacement contents, and supplement specification uploader 225 may communicate the identification of the supplemental or replacement contents.

Supplemental downloader 230 downloads supplemental contents. In some embodiments, supplemental downloader 230 may download contents to replace outdated or inaccurate static contents. For example, supplemental downloader 230 may download previews of movies about to arrive in theatres to replace previews of movies which have already left theaters. In some embodiments, supplemental downloader 230 may download supplemental contents to be played in addition to static contents, such as advertisements. In some embodiments, supplemental downloader 230 may download information about choices of supplemental contents. For example, supplemental downloader 230 may download a list of available previews for selection by the user.

Contents player 270 includes media reader 265 and media presenter 250. Contents player 270 reads contents stored on a storage medium and presents the contents to a user. Contents player 270 may read and present videos or audio from a DVD or CD, audio from a cassette tape or MP3 player, slides or other still pictures from digital storage medium, and other contents from other medium known to those of skill in the art. Media reader 265 includes tag reader 260 and content reader 255. Content reader 255 reads contents to be presented to a user. Tag reader 260 reads tags. Static media content may be tagged with information about the content. For example, a tag for a preview of a movie may include an expiration date, a list of actors, the director, a list of writers, or a list of other participants in the movie. The tags may be used to determine whether to replace the tagged contents and, if so, to select supplemental contents. The tags may consist of XML-type structures, XML or Extensible Markup Language was developed by the XML working group in 1996. XML structures may consist of elements. Each element may consist of a start tag designated by brackets (< >), content, and a closing tag, designated by (</>). An XML element may be hierarchical. The content of an element may itself be an element. An example of an simple XML element is:
<pitcher>Greg Maddux</pitcher>
   The beginning and end tags describe an attribute or category, pitcher. The content describes the value of the attribute, a designation of a particular pitcher, Greg Maddux.

An example of a hierarchical tag for a DVD is:

<DVD>

<Title>Tootsie</title>
<genre>comedy</genre>
<year>1982</year>
<language>English</ language >
<cast>Dustin Hoffman</ cast >
< cast >Jessica Lang</ cast >
< cast >Teri Garr</ cast >
< crew >

< director >Sydney Pollack</ director >

</crew>

</DVD>

In this example, the content of the DVD element consists of several XML elements, title, genre, year, language, cast, and crew. There are three cast elements in the content of the DVD element. The content of the crew element is again an XML element. This example is for illustration only, and not for limitation. In some embodiments, XML-type structures may use other methods of marking the beginning and end of an element. In some embodiments, the tags may not be hierarchical.

Media presenter 250 may present static contents of a storage medium to a user and may present supplemental contents to a user. Media presenter 250 may include a screen or other device for presenting images and may include speakers or other devices for presenting audio.

Replacement manager 245 includes obsolesce determiner 240 and supplemental contents selector 235. Replacement manager 245 determines whether to supplement the contents of storage media and, if so, determines supplemental contents. Replacement manager 245 may determine that static contents stored on a medium is obsolete or otherwise should be replaced or may determine that additional contents should be presented without replacing any stored contents.

Obsolesce determiner 240 may determine that static contents on a storage medium is out of date or otherwise should be replaced. The static contents may be out of date when it advertises a product or performance that is no longer available. For example, the obsolesce determiner 240 may determine that a movie preview is out of date when the movie is no longer playing in theatres in the region in which the static content supplementer 200 is located. A preview of a live concert may be out of date when the concert has already occurred. An announcement may be out of date when newer information is available. For example, an announcement that a movie has been nominated for awards may be out of date after the movie wins an award. In some embodiments, an obsolesce determiner 240 may determine that advertising about a product is out of date when newer or better-selling products are available. For example, a preview of a movie released in DVD format may be out of date when the movie has been out for a few months and newer movies have been released in DVD. Similarly, a preview of a video may be out of date when the video has been released and is not selling well, when another video has been released and is selling well, or when a video is about to be released and anticipated sales are large. For example, a preview of a movie may be outdated when a preview of another movie which won an Academy Award becomes available. Obsolesce determiner 240 may also determine to replace erroneous or incomplete static content. For example, a slide showing text may contain incorrect information or a list of cast member may be incomplete.

In some embodiments, obsolesce determiner 240 may make use of tags on static content to determine to replace the static content. In some further embodiments, the tags may indicate an expiration date. In other further embodiments, the tags may identify the static content. A data base search based upon the identify may then determine whether the static content is outdated. In alternative embodiments, an identification number of the storage medium may provide the basis for a data base lookup. In other embodiments, image processing may be used to identify obsolete contents. For example, in a movie CD which does not make use of tagging, image processing may be used to distinguish between the previews and the movie. The obsolesce determiner 240 may determine the previews to be out of date. In still other embodiments, obsolesce determiner 240 may use rules to determine whether static content is outdated. In some further embodiments, the rules may be general, based upon release date. For example, a preview of a movie may be out of date when the preview has been released for a month. In other further embodiments, the rules may be specific to the particular static content.

Supplemental content selector 235 selects content to supplement static contents. In some embodiments, supplemental content selector 235 may be based on rules. The rules may search for supplemental content similar to static content that the obsolescence determiner 240 determined was out of date or otherwise in need of replacement. For example, in replacing a movie preview, the rules may select a preview of the same genre, the same main character, the same director, the same author, the same time period, or the same studio as the preview. In some further embodiments, the rules may be applied to information provided by tags placed upon the static content. The rules may also be applied to information provided by tags placed upon potential supplemental content. For example, a rule may utilize a tag describing the genre of a preview to replace the preview with a preview of the same genre. A preview of a comedy could be replaced with a preview of a more recent comedy. The genre of the supplemental material may be determined from a tag placed upon the supplemental material. In some embodiments, the supplemental content selector 235 may base the selection of supplemental content on an identification of the static content. For example, the supplemental content selector 235 may determine replacement contents based upon a CD or DVD identification number. The contents player 270 may read the identification number and provide the identification number to the supplemental content selector 235. As another example, the supplemental content selector 235 may determine replacement contents based upon an identity of outdated static content, such as an outdated movie preview. In some embodiments, the supplemental content selector 235 may search a data base to select supplemental content. In alternative embodiments, the supplemental content selector 235 may interact with a user to determine supplemental content. The supplemental content selector 235 may select a list of possible replacement contents and present them to the user for selection. The supplemental content selector 235 may base a selection of supplemental content on preferences obtained from a user.

In some embodiments, replacement manager 245 may be a component of the device containing the contents player 270. In other embodiments, replacement manager 245 may communicate over a network with network module 220. In still other embodiments, a portion of replacement manager 245 may be a component of the device containing the contents player 270 and a portion of the replacement manager 245 may communicate over a network with network module 220. For example, in some embodiments, obsolescence determiner 240 may be located in the same device as the contents player 270, and supplemental content selector 235 may communicate through network module 220 with contents player 270.

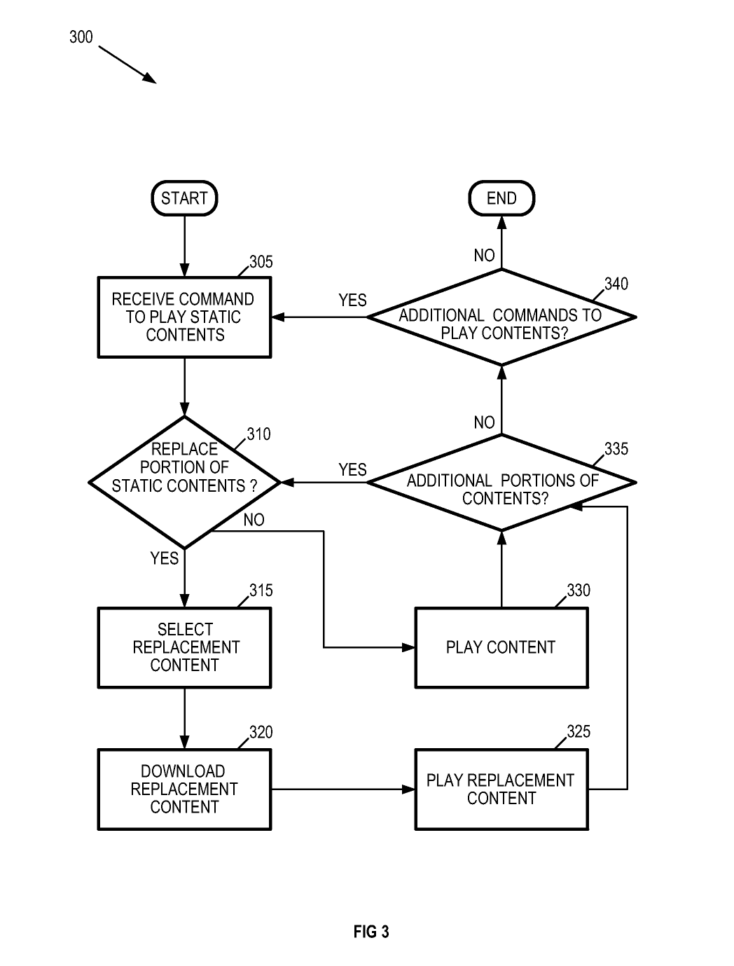

FIG. 3 depicts a flowchart of an embodiment to supplement static contents. Flow chart 300 begins with receiving a command to play static contents (element 305). The command may comprise a command to play specific static content, such as a movie or a preview of a movie on a CD, DVD, or VHS tape; a particular song on a CD, DVD, or audio cassette; or a slide or a photograph from a file containing still images. For example, a user may navigate to a particular scene of a movie and give a command to play the scene. The command may also comprise a general command to play the contents of a storage medium. For example, a user may click the play button on a VCR.

A decision is then made whether to replace the static contents or a portion of it (element 310). Static content may be replaced when it is out of date. A preview of a movie or a music video may be out of date when the movie or music video has been released for some time. Static content may also be replaced when it is inaccurate. For example, a slide showing text may contain incorrect information. If static content is to be replaced, replacement content is determined (element 315). The replacement content may be determined by rules, by interaction with a user, from an identity of a disk or tape containing the static content or an identity of the static content, or by other means. The rules may select replacement content similar to the static content to be replaced. For example, a movie preview may be replaced by a movie preview of the same genre, actors, director, or writers. The selection of replacement content may utilize a data base of available static content. The replacement content is then downloaded (element 320) and played (element 325). In some embodiments, a user may be allowed to opt out of the playing of replacement content. In some embodiments, a user may be asked for approval before the playing of the replacement content.

If the decision is not to replace the static contents or a portion of it, then the static contents or portion of static contents is played (element 330). If there are additional portions of content covered by the command to play static contents, such as additional previews, then the elements from 310 to 330 may be repeated (element 335). If there are additional commands to play static contents, then the elements from 305 to 335 may be repeated (element 340). Otherwise, if there are no other portions of static contents covered by the command to play static contents and there are no other commands to play static content, then the supplementing of static content may end.

Another embodiment of the invention is implemented as a program product for supplementing static contents. The program(s) of the program product defines functions of the embodiments (including the methods described herein) and can be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of the present invention, represent embodiments of the present invention.

In general, the routines executed to implement the embodiments of the invention may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods and arrangements to supplement static contents. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of supplementing static contents, the method comprising:
receiving a command to play static contents, the static contents comprising primary content and an original preview;
deciding to replace the original preview in the static contents;
selecting replacement content for the original preview;
downloading the replacement content; and
playing the replacement content in place of the original preview.

2. The method of claim 1, further comprising:
allowing a user to opt out of replacing the original preview.

3. The method of claim 1, wherein the selecting comprises selecting replacement content comprising a type of content from a group of types of content comprising newer previews, advertisements, announcements of live performances, public service messages, anti-piracy messages, updates on awards, and corrections to the static contents.

4. The method of claim 1, wherein the deciding comprises:
determining a date for the original preview; and
deciding to replace the original preview based upon the date.

5. The method of claim 1, wherein the deciding comprises:
image processing the original preview; and
deciding to replace the static contents based upon the image processing.

6. The method of claim 1, wherein the selecting comprises:
tagging the static contents with information about the static contents;
reading the information; and
selecting replacement content based upon the information.

7. The method of claim 1, wherein the selecting comprises:
selecting replacement content via the application of rules.

8. The method of claim 1, wherein the selecting comprises:
selecting replacement content via an interactive user interface.

9. An apparatus to supplement static contents, the apparatus comprising:
a user interface to receive a command to play static contents, the static contents comprising primary content and an original preview;
a replacement manager to decide to replace the original preview in the static contents and to select replacement content;
a network module to download the replacement content; and
a contents player to play the downloaded replacement content.

10. The apparatus of claim 9, wherein the apparatus comprises a player from a group of players comprising compact disk (CD) players, DVD players, Video Home System (VHS) tape players, Blue-ray disk players, HD-DVD players, and audio cassette players.

11. The apparatus of claim 9, wherein the replacement manager is configured to interact with a user through the user interface to select replacement content.

12. The apparatus of claim 9, wherein:
the static contents comprises tags with information about the content; and
the replacement manager is configured to select replacement content based upon the information.

13. The apparatus of claim 9, wherein the replacement manager is configured to select replacement content based upon the application of rules.

14. A machine-accessible medium containing instructions to supplement static contents, which when executed by a machine, cause said machine to perform operations, comprising:
receiving a command to play static contents, the static contents comprising primary content and an original preview;
deciding to replace the original preview in the static contents;
selecting replacement content for the original preview;
downloading the replacement content; and
playing the replacement content in place of the original preview.

15. The machine-accessible medium of claim 14, wherein the operations further comprise allowing a user to opt out of replacing the original preview.

16. The machine-accessible medium of claim 14, wherein the selecting comprises selecting replacement content comprising a type of content from a group of types of content comprising newer previews, advertisements, announcements of live performances, public service messages, anti-piracy messages, updates on awards, and corrections to the static contents.

17. The machine-accessible medium of claim 14, wherein the deciding comprises:
image processing the original preview; and
deciding to replace the static contents based upon the image processing.

18. The machine-accessible medium of claim 14, wherein the selecting comprises:
tagging the static contents with information about the static contents;
reading the information; and
selecting replacement content based upon the information.

19. The machine-accessible medium of claim 14, wherein the selecting comprises selecting replacement content via the application of rules.

20. The machine-accessible medium of claim 14, wherein the selecting comprises selecting replacement content via an interactive user interface.
